(19) United States
(12) Patent Application Publication
(10) Pub. No.: US 2021/0205658 A1
(43) Pub. Date: Jul. 8, 2021

(54) EXERCISE SYSTEM

(71) Applicants: Anuj Patel, Kingston, NY (US); Andrew Page, New York, NY (US)

(72) Inventors: Anuj Patel, Kingston, NY (US); Andrew Page, New York, NY (US)

(21) Appl. No.: 17/203,060

(22) Filed: Mar. 16, 2021

Related U.S. Application Data
(62) Division of application No. 15/585,685, filed on May 3, 2017.
(60) Provisional application No. 62/330,895, filed on May 3, 2016.

(51) Int. Cl. A63B 24/00; H04M 1/72403; A63B 21/072; A63B 71/06

(52) U.S. Cl. CPC A63B 24/0003; H04M 1/72412; A63B 21/0724; A63B 24/0062; A63B 24/0075; A63B 71/0622; A63B 21/072; A63B 2220/13; A63B 2225/50; A63B 2220/17; A63B 2220/836; A63B 2210/50; A63B 2209/10; A63B 2220/40; A63B 2220/51; A63B 2220/833; A63B 2230/75; H04M 1/72403

(57) ABSTRACT

An exercise apparatus, system, and method are provided herein, in which an exercise apparatus has a tracking mechanism comprising a gyroscope, processor and transmitter. The user may wear a sensor, for example, on his shoe. The gyroscope detects the position of the exercise apparatus with respect to the sensor, and thus detects the motions made by the user with the apparatus. A mobile device such as a cellular phone may have an application running thereon, which tracks these motions, and notify the user if the user's form is incorrect, and preferably provides an image of the proper form. The exercise apparatus may include wheels with which the exercise apparatus may be rolled.

### CROSS REFERENCE TO RELATED APPLICATIONS

The application is a division of U.S. application Ser. No. 15/585,685, filed on May 3, 2017, which claims the benefit of U.S. Provisional Application No. 62/330,895, filed on May 3, 2016, which is incorporated by reference herein in its entirety.

### FIELD OF INVENTION

The invention is related to a system and device for tracking the movement of an athletic equipment with respect to the user, and a method of using such system and device.

### BACKGROUND OF THE INVENTION

The invention relates generally to an exercise system and device, for example for weightlifting.

An exercise routine often involves displacing objects in order to exercise the muscles controlling such motions. Such objects may be barbells, dumbbells, or other weighted objects. The person may watch themselves in the mirror or have someone they know watch them, but unless they are trained, they may be unable to notice improper form, especially, if it is subtle. The person may hire a personal trainer but personal trainers may be expensive. However, with certain exercises, if it is done with improper form, the person may end up hurting themselves.

Alternatively, the person may follow an instructor. If the instructor is in the same room, the instructor may be able to come by and correct the person's form. However, the instructor often has multiple people in the class to tend to, and may be unable to notice every mistake of every person in the room. If the instructor is not present, for example if the person is watching a workout video, there is no one available to tell the person if their form is incorrect or if mistakes are being made.

Accordingly, it is desirable to provide an improved system and device for tracking athletic equipment with respect to the user which overcomes drawbacks and inadequacies of known methods and systems.

### SUMMARY OF THE INVENTIONS

Generally speaking, in accordance with an embodiment of the invention, an exercise equipment such as a bar onto which weights can be connected includes a tracking mechanism having a gyroscopic sensor, a transmitter, and processor and a battery. More preferably, the tracking mechanism is located in an end cap or other removable piece that may be used on various bars. For example, the end cap may be used on a barbell as well as a dumbbell.

Another embodiment of the invention provides a sensor for communicating with the tracking mechanism. For example, the sensor may be positioned on the user's shoe. The tracking mechanism may communicate with the sensor and/or work in tandem with the sensor to provide positional information of the exercise equipment with respect to the sensor. A mobile application on the user's phone may track the movement of the exercise equipment with respect to the sensor.

Yet another embodiment of the invention monitors the user's position and offers corrections via notifications.

Another embodiment of the invention monitors the exercise performed, such as the speed, acceleration, repetition, force, cadence, etc.

An embodiment of the invention provides a workout regimen utilizing a tracking mechanism and sensor.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawing, in which:

FIG. 1 is an illustration of a system in accordance with an embodiment of the invention;

FIG. 2 is a partially exploded front view of an apparatus in accordance with an embodiment of the invention;

FIG. 3 is a front view of the apparatus of FIG. 2 without weights

FIG. 4 is a cross sectional view of an end cap of the apparatus of FIG. 3 taken along view lines A-A;

FIG. 5 is a cross sectional view of an end cap of the apparatus of FIG. 3 taken along view lines B-B;

FIG. 6 is an exploded view of a rod in accordance with an embodiment of the invention;

FIG. 7 is a front perspective view of an apparatus in accordance with an embodiment of the invention;

FIG. 8 is a magnified view of a portion of the apparatus of FIG. 7 the invention in a first position;

FIG. 9 is a magnified view of a portion of the apparatus of FIG. 7 the invention in a second position;

FIG. 10 is a magnified view of a portion of the apparatus in FIG. 7 showing the end cap, securing member, and stopper;

FIG. 11 is a schematic view of the end cap of the apparatus of FIG. 7; and

FIG. 12 is a magnified view of a portion of an embodiment of the invention.

### DETAILED DESCRIPTION OF THE PREFERRED EMBODIMENTS

The invention generally is directed to a system and device for tracking the movement of an object such as athletic equipment with respect to a user, and a method of exercising using said system and device. More specifically, the invention is directed to a system which gathers data on the exercise being performed by the user and providing feedback thereon.

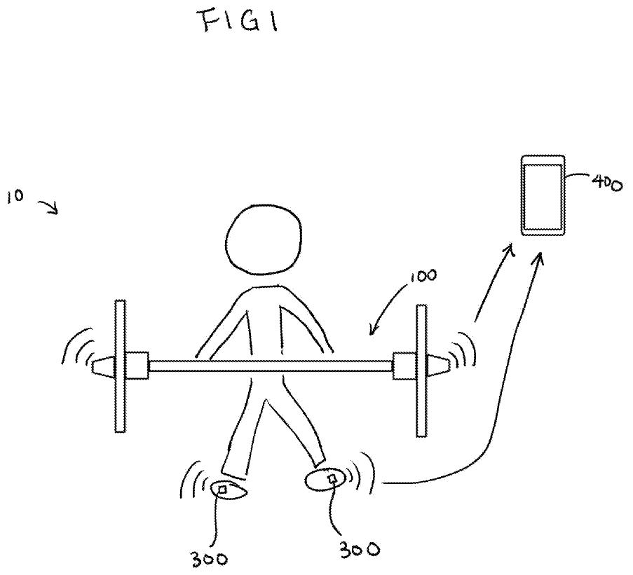

A system 10 in accordance with an embodiment of the invention is illustrated in FIG. 1, comprising an apparatus 100 having end caps 200, as well as sensors 300, and a mobile device 400. End caps 200 and sensors 300 preferably each include a transmitter to transmit data to mobile device 400, such as movement and positioning data of end caps 200. Mobile device 400 may be a cellular phone, tablet, gaming device, computer, or other suitable device for processing data, and need not be mobile as the illustrated embodiment. Preferably, mobile device 400 runs an app (mobile application) or software for tracking the movement of apparatus 100 with respect to sensors 300. Sensors 300 as illustrated are located on the user's feet. For example, sensors 300 may be clipped on or otherwise attached to the user's shoes. End cap 200 may work in tandem with sensors 300 and synced to the app or software.

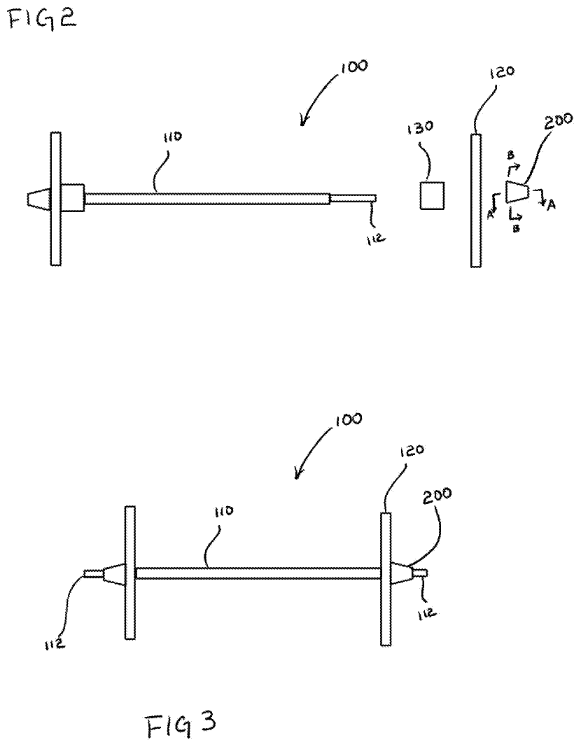

Reference is made to an embodiment of apparatus 100 shown in FIGS. 1-3, wherein an end cap 200 is connected to a rod 110 proximate a tip 112 of rod 110. Apparatus 100 also includes a pair of wheels 120. Preferably, end caps 200 prevent wheels 120 from being dislodged from rod 110. A weight 130 may be added as illustrated in FIGS. 1-2 for added resistance or removed as illustrated in FIG. 3. As shown in FIGS. 2 and 3, tip 112 of rod 110 may extend beyond end cap 200 when there is no weight 130, in contrast to when weight 130 is added. Preferably, weight 130, wheel 120 and end cap 200 include apertures through which tip 112 of rod 110 may be inserted during assembly.

Whereas the embodiment of weight 130 illustrated is smaller in size than wheel 120, it is to be understood that weight 130 may have a different size or shape than illustrated, and may be the same size or larger than wheel 120. For example, standard weight plates may be attached to rod 110. Furthermore, an alternate embodiment of apparatus 100 may be provided without wheels 120. For example, when weight 130 is the same size or larger than wheel 120, it may be preferred to remove wheels 120. Apparatus 100 may be provided with rod 110 and end cap 200 with or without weight 130, and without wheel 120. For example, it may be desired to have a smaller or lighter apparatus 100 without wheels 120. Other objects, such as a foam pad, cellular phone such as a smartphone, camera, speaker, etc. may be added to apparatus 100 without deviating from the scope of the invention.

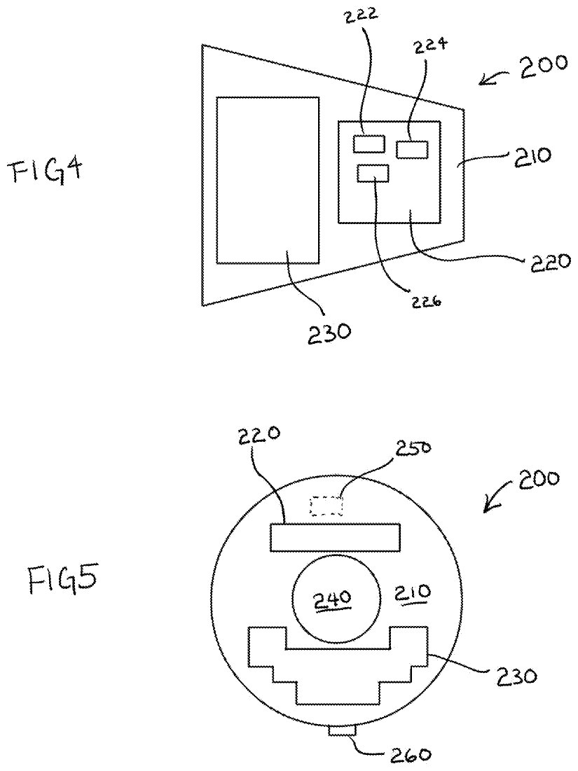

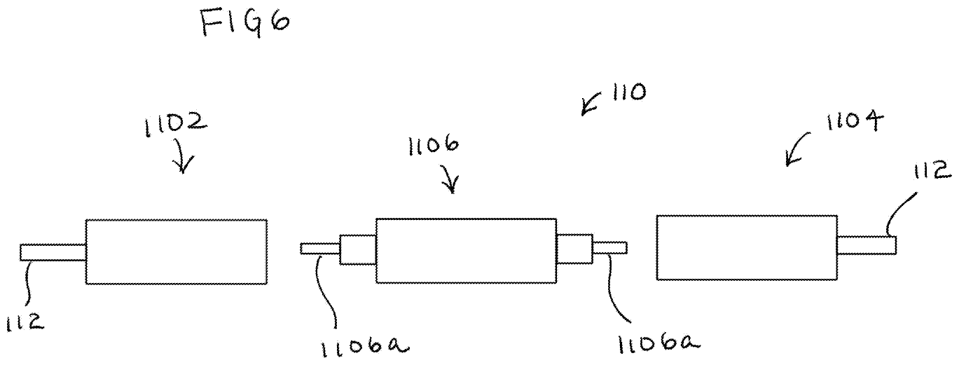

In the embodiment illustrated, end cap 200 is a tracking mechanism. Reference is made to FIGS. 4-5, which illustrate the internal mechanism of end cap 200. End cap 200 as shown includes a housing 210 encasing a circuit board 220 and a battery 230. End cap further includes a power switch 250 to turn on/off the motion tracking capabilities and a charging port 260, preferably a micro-USB charging port, for charging battery 230. Battery 230 is preferably a rechargeable battery, more preferably a lithium ion battery, such as a 3.7V lithium ion battery. Power switch 250 may be exposed or otherwise accessible for the user to turn on the tracking capabilities of end cap 200. Alternatively, the tracking capabilities may be turned on automatically upon the proper installation of end cap 200. For example, when end cap 200 is positioned onto tip 112 and locked in place, for example by rotating it about tip 112, transmitter 222 may be automatically turned on.

Circuit board 200 preferably includes a transmitter 222 such as a Bluetooth radio, a gyroscope 224, and a processor 226. Transmitter 222 may alternatively be a BTLE (Bluetooth Low Energy), NFC (Near-Field Communicator) transmitter, or any other suitable transmitter for communicating with the desired device, for example mobile device 400. Gyroscope 224 is preferably a 6-axis gyroscope, and processor 226 is preferably a 10-bit processor or greater. Transmitter 222 may also communicate with sensor 300. For example, transmitter 222 may detect the position of sensor 300 may and send the collective data regarding the position of end cap 200 and sensor 300 to mobile device 400, rather than sensor 300 transmitting a signal on its own.

Rod 110 may be constructed of a suitable material, such as aluminum, more preferably anodized aluminum which may provide a lightweight rod 110. Preferably, rod 110 has a diameter of between 1 inch and 3 inches, more preferably between 1.5 inches and 2.5 inches, most preferably about 2.5 inches. Standard weight plates commonly found in gyms, having standardized center openings of 2 inches may be connected to rod 110.

In accordance with the embodiment illustrated in FIG. 6, rod 110 comprises three pieces 1102, 1104, 1106. Center rod 1106 has a protrusion 1106a on either end. End rods 1102, 1104 have a cavity for receiving protrusion 1106a to connect center rod 1106 to end rods 1102, 1104 to assemble rod 110. Preferably, the lengths of center rod 1106 and end rods 1102, 1104 are approximately 14.2 inches for center rod 1106 and approximately 19.7 inches for end rods 1102, 1104, not including protrusions 1106a and tips 112. Preferably, rod 110 has a texture to enhance grip, such as a diamond pattern texture. Protrusions 1106a and tips 112 are preferably molded vinyl compounds and may be attached to its respective center rod 1106 or end rod 1102, 1104 via screws, and are preferably not removable therefrom.

Center rod 1106 and end rods 1102, 1104 preferably engage and stay connected via an assembly mechanism such as a turn-and-lock mechanism described in further detail below, threaded connectors, or other suitable means. Providing a rod 110 that may be disassembled may facilitate storing and/or transporting apparatus 100.

Wheel 120 preferably includes an internal ball bearing or other mechanism to permit wheel 120 to rotate independently of rod 110 after locking onto rod 110. Alternatively or in combination, tip 112 of rod 110 may be part of an internal bearing, so that wheel 120 can rotate via the bearing. More specifically, a user may hold onto rod 110 and roll apparatus 100 on the floor without rod 110 rotating. Wheel 120 preferably has a standard center opening of 2 inches in diameter, similar to standard weight plates, and an outer diameter of between 18 to 19 inches, which may facilitate exercises for the average sized adult. Wheel 120 preferably also includes an inner rubber tube or tire, preferably an inflatable tire with an inner tube, and has a thickness of wheel 120 is preferably about 1.5 inches. An exemplary embodiment of wheel 120 is lightweight, and is injection molded from high strength vinyl composite.

A preferred embodiment of end cap 200 also has a 2-inch opening to receive tip 112 of rod 110 and is constructed of vinyl composite. End cap 200 preferably has a length of 1.5 inches to 3.5 inches, more preferably approximately 2.5 inches, and a width of approximately 3 inches tapering down to approximately 2 inches, more preferably 1 15/16^{th} inches. End cap 200 as shown is hollow to permit tip 112 to extend therethrough as illustrated in FIG. 3. End cap 200 may further have a twisting locking mechanism to keep it in place.

Preferably, apparatus 100 weighs less than 9 lbs, which may further facilitate transporting apparatus 100 as well as facilitate persons of various athletic abilities to utilize apparatus 100.

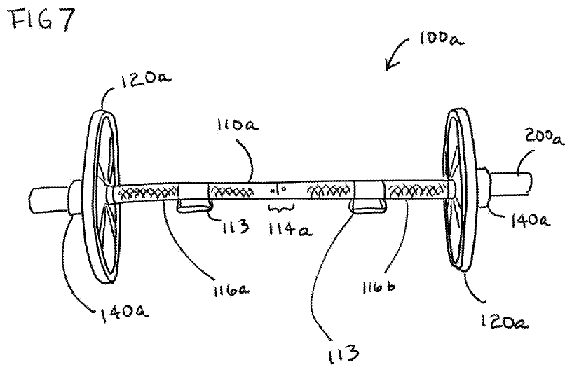

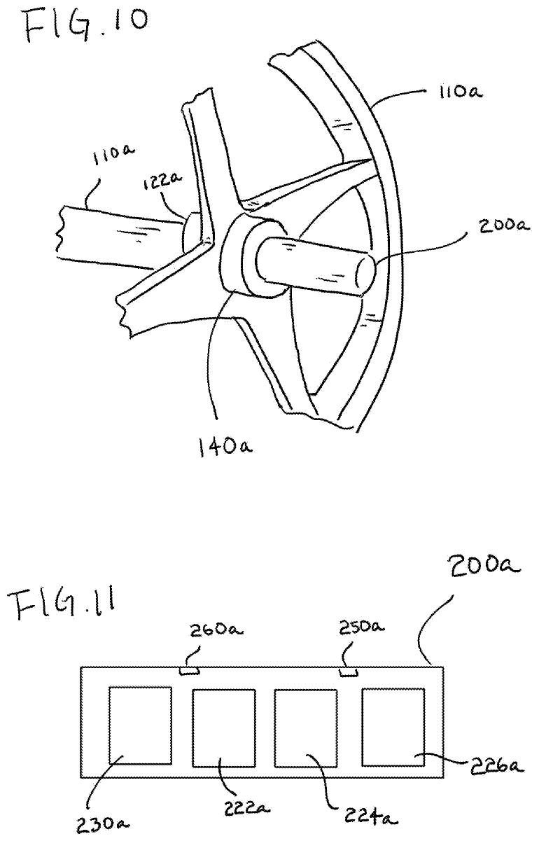

Reference is made to another embodiment of apparatus 100a shown in FIGS. 7-11, wherein an end cap 200a is connected to a rod 110a at either end of rod 110a. Apparatus 100a also includes a pair of wheels 120a each secured on the inner side by a stopper 122a and by a securing member 140a, such as a barbell collar, on the outer side. Stopper 122a may be fixed to rod 110a, such that when rod 110a is inserted into a corresponding aperture of wheel 120a, preferably such that rod 110a is coaxial with wheel 120a, stopper 122a prevents wheel 120a from moving farther into rod 110a. Once wheel 120a is positioned, securing member 140a is preferably placed on the outer side of wheel 120a and locked, thus securing wheel 120a in position.

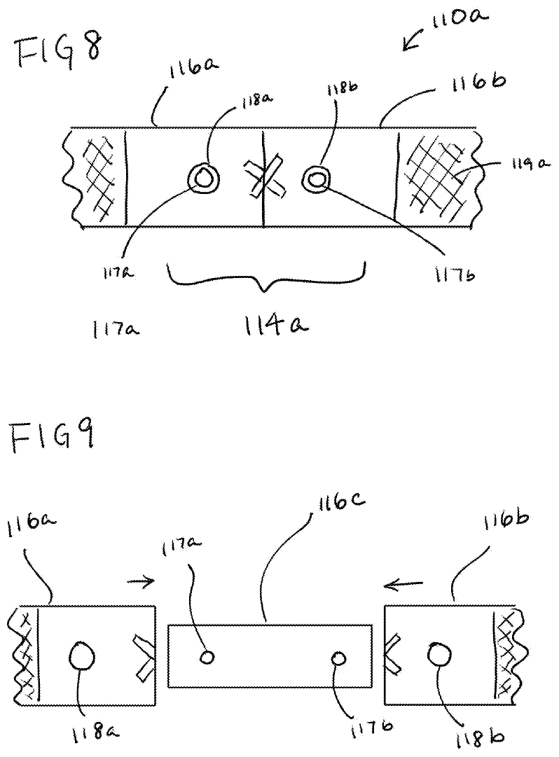

Rod 110a preferably comprises a plurality of rod pieces 116a, 116b, 116c that are assembled to form a long rod, or disassembled for storage or transport. A preferred embodiment of rod 110a has a length of 55 inches when assembled, and a wheelbase of 40.5 inches between wheels 120a. As shown in more detail in FIGS. 8-9, each end of rod piece 116c may be inserted into a corresponding cavity of rod pieces 116a and 116b and secured. Rod pieces 116a, 116b, 116c may be connected via an assembly mechanism 114a, such as a turn-and-lock mechanism as illustrated in FIGS. 8-9. For example, rod piece 116a has an aperture 118a, rod piece 116b has an aperture 118b, and rod piece 116c has a first protrusion 117a and a second protrusion 117b. Rod piece 116c is inserted into rod piece 116a and rotated with respect thereto until first protrusion 117a extends through aperture 118a. Preferably, a stopper prevents rod piece 116c from being inserted too far, thus aligning first protrusion 117b to aperture 118a. In similar fashion, rod piece 116c and rod piece 116b may be connected to assemble rod 110a. It is to be understood that alternate assembly mechanisms are contemplated without deviating from the scope of the invention, by way of non-limiting example, a threaded connectors, or a friction-fit mechanism.

Whereas the embodiment illustrated show three rod pieces 116a, 116b, 116c, the number of rod pieces may be varied to obtain the desired length of rod 110a without deviating from the scope of the invention. The rod pieces may have uniform length or vary in length, but preferably provides a balanced rod 110a having an equal weight on either side of the center of rod 110a when assembled.

Rod 110a preferably has a diameter of 1.5 inches, which may facilitate planking and/or rolling while holding onto rod 100a. Rod 110a preferably weighs approximately 5 lbs, and apparatus including rod 110a, wheels, 120a, and securing member 140a preferably weighs approximately 11.2 lbs. The preferred maximum weight of apparatus 100a with weights is 350 lbs. Rod 110a preferably also has a textured surface 119a which preferably enhances grip.

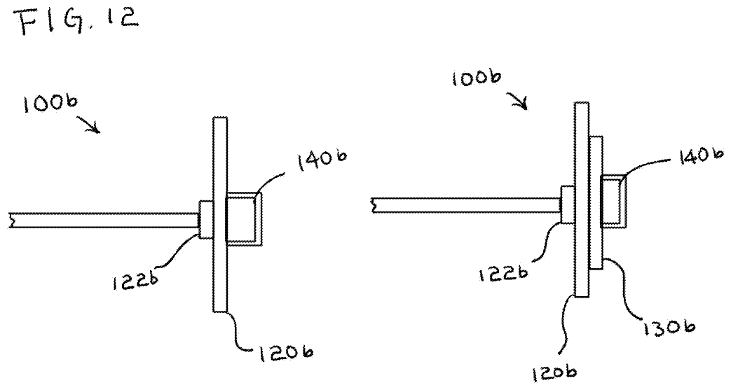

Referring to FIG. 11, the embodiment of end cap 200a includes a battery 230a, transmitter 222a, a gyroscope 224a, and a processor 226a housed within for tracking the movement of apparatus 100a. A switch 250a and a charging port 260a may also be provided. End cap 200a preferably has a diameter of 2 inches so that standard weight plates and barbell collar may be used. Securing member 140a preferably comprises a fast-latch system facilitating loading and unloading of weight 130 and wheel 120.

Referring to FIG. 7, the illustrated embodiment of rod 110a includes a pair of straps 113 which a user may use to secure their feet to rod 110a, which may facilitate certain exercises. Strap 113 is preferably adjustable and removable from rod 110a, and includes padding for enhancing comfort. Strap 113 preferably also includes injected molded ABS plastic or similar material, which may enhance grip against the users shoes.

As shown in FIG. 12, an embodiment of apparatus 100b includes a wheel 120b, weight 130b, stopper 122b, and securing member 140b to maintain wheel 120 and weight 130b in position.

An exemplary embodiment of the use of system 10 will be described herein. The user places sensors 300 on their shoes, assembles apparatus 100, and powers on the tracking mechanism of end cap 200. When apparatus 100 is placed by the user's feet, and the app (collectively app or software) is activated, the user may calibrate sensors 300 by moving apparatus 100 as instructed via the app. Once calibrated, the user may begin exercising using apparatus 100, for example, on their own, follow a regimen preferably provided via the app, within a group, or with a personal trainer. When a user displaces apparatus 100, its movement with respect to sensors 300 is measured and transmitted to mobile device 400.

Preferably, the user creates a profile prior to beginning exercise. The profile may include information such as age, weight, height, athletic ability, and gender. The profile data may be used to determine the desired position based on the biomechanical movements of a human being of the same profile as the user. Thus, if it is determined that the user has strayed from the desired position, he may receive a notification via mobile device 400, along with a suggestion on the correct form.

For example, a user does a plank while grasping rod 110 with his hands, and based on the user's height, the preferred distance (or range of distances) between apparatus 100 and sensors 300 would be determined. If the distance deviates from the desired distance, the user is notified via the app on mobile device 400. Likewise, a preferred distance between the feet may be calculated and the user may be notified if the distance deviates therefrom. Preferably, the preferred distance is a range of distances.

The system 10 may also monitor the energy exerted by the user via force generated by the movement of apparatus 100, and may thus help maximize output of the exercise. For example, the system 10 may measure total calories burned, total watts produced, maximum force exerted, etc.

A preferred exercise regimen includes one or more squats, bilateral planks, unilateral planks, lunges, deadlifts, and/or derivatives thereof. An embodiment of the invention provides for sensors 300 and/or apparatus 100 to continuously monitor the user's position and offer corrections via the app. For example, if it is determined that the user is doing the exercise incorrectly, the app may give a notification via mobile device 400 to help the user correct his form, posture, etc, preferably in real time. This may assist the user to fix his posture, which may prevent injury.

The app may illustrate which exercises to do, preferably including an image or video of the exercise. As the user does the exercise, in addition to monitoring the movement and alerting the user of incorrect form as described above, the app may keep count of the repetitions, breaks taken, speed of each rep, alert the user to speed up or slow down, display a message to encourage the user to keep going, etc.

An embodiment of the invention includes providing a class in which students exercise using apparatus 100, 100a. The students may use their mobile devices 400, preferably relatively in sync, or follow an instructor in the room. When a student deviates from the desired form, their mobile device 400 will preferably alert them, which may lessen the dependency on the instructor, and which may facilitate the instructor leading the class. In such a setting, it may be preferred for the notifications to be sent to the user via a headset or other wearable device, which may help avoid accidentally damaging their mobile device, reduce the number of notification sounds going off in the room, etc. For example, mobile device 400 may be in the room and send a Bluetooth or other signal to a headset with an audio notification that the user's form is incorrect. The user may look up at the instructor, check their form, check their mobile device, etc. to determine how to correct the form. More preferably, mobile device 400 will send an audio message to the user with instructions on how to correct their form, for example, “Move feet closer to the bar,” “Spread out feet farther,” “You are moving the bar too far forward,” etc.

Whereas the embodiments described above are directed toward a barbell, it is to be understood that the apparatus may generally be a dumbbell, curl bar, kettlebell, or other weightlifting equipment. Alternatively, the apparatus may be different athletic equipment, such as a golf club, tennis racket, etc. having a tracking mechanism therein to communicate with one or more sensors worn by the user to track the movement of the apparatus with respect to the user. For example, the gyroscope in a golf club may track the movement of the club in space with respect to the user's posture and communicate such data to a mobile device.

Other alterations may be made without deviating from the scope of the invention. Accordingly, the system, method, device, use thereof, etc. may be varied as a matter of application specific design choice without deviating from the scope of the invention. For example, end cap 200 may be used with another barbell, dumbbell or other rod onto which it can fit, thus retrofitting the equipment. Alternatively, the tracking mechanism may be worn on another part of the body of the user. For example, it may be attached to a headband, cap, wristband, watch, bracelet, etc. to monitor the user's movement and provide notifications, track exercise, etc. Furthermore, the number of tracking mechanisms, sensors and mobile devices working together may be varied. Additionally, whereas the end caps having the tracking mechanisms are illustrated as being located at the tip of the rod, it is to be understood that a tracking mechanism may be attached to the rod more proximate the center of the rod. For example, within the rod, proximate a stopper by the wheel, or anywhere else along the length of the rod.

Moreover, the tracking mechanism may be connected to the rod using alternative means as desired. By way of non-limiting example, the tracking mechanism may be attached via Velcro, an adhesive, fabric, thread, wires, molding such as injection-molding, or any other suitable means as a matter of application-specific design choice. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between.

We claim:

1. A system for tracking movements during exercise, the system comprising:
an exercise apparatus having a rod, one or more wheels which rotate freely about said rod, and a tracking device,
wherein said tracking mechanism comprises a gyroscope, a processor, a power source, and a transmitter which transmits data to a processing device;
a sensor device; and
a processing device having a screen, said processing device calculating a first position of said sensor with regard to said tracking device, said processing device connected to a screen displaying a notification if said first position is outside of an acceptable area calculated by said processing device.

2. The system of claim 1, wherein said processing device calculates a second position of said sensor with regard to said tracking device.

3. The system of claim 1, wherein said processing device calculates a speed at which said exercise apparatus was displaced with respect to said sensor device;

4. The system of claim 1, wherein said processing device calculates a force at which said exercise apparatus was displaced with respect to said sensor device;

5. The system of claim 1, wherein said processing device displays an image of a suggested posture at which to perform an exercise.

6. The system of claim 1, wherein said processing device:
receives a user profile including a user height;
displays an image of a motion to perform as part of an exercise regimen;
calculates a desired area within which said apparatus is to be displaced from said sensor based on said user profile; and
displays a notification if a displacement path of said apparatus from said sensor is outside of said desired area.

7. The system of claim 1, wherein said processing device counts a number of times said apparatus is displaced from said sensor.

8. The system of claim 1, wherein said processing device is a mobile device.

9. A method of exercising comprising:
installing an application on a mobile processing device having a screen;
entering a user profile into said application, said user profile including the user's height;
attaching a sensor on a user;
attaching a tracking mechanism on an exercise apparatus, said tracking mechanism having a gyroscope, a processor, and a transmitter;
calculating a calculated motion via said application based on said user profile, said calculated motion having an accepted deviation;
moving said exercise apparatus creating an action motion;
generating an action motion data and transmitting said action motion data to said mobile processing device;
tracking said action motion on said mobile processing device via said application;
receiving a notification via said mobile processing device if said action motion deviates from accepted deviation.
